(19) United States
(12) Patent Application Publication
(10) Pub. No.: US 2008/0003512 A1
(43) Pub. Date: Jan. 3, 2008

(54) IMAGE FORMING METHOD

(75) Inventors: Yoshiaki KOBAYASHI, Tokyo (JP); Asao MATSUSHIMA, Tokyo (JP); Noboru UEDA, Tokyo (JP)

Correspondence Address: LUCAS & MERCANTI, LLP, 475 PARK AVENUE SOUTH, 15TH FLOOR, NEW YORK, NY, 10016, US

(73) Assignee: KONICA MINOLTA BUSINESS TECHNOLOGIES, INC., Tokyo (JP)

(21) Appl. No.: 11/764,942

(22) Filed: Jun. 19, 2007

(30) Foreign Application Priority Data
Jul. 3, 2006 (JP) 2006183091

(51) Int. Cl. G03G 13/04

(52) U.S. Cl. 430/48

(57) ABSTRACT

An electrophotographic image forming method is disclosed, comprising forming a toner image, transferring the toner image onto a recording medium and fixing the transferred toner image in a fixing device comprising a heating roller, an endless belt pressed into contact with the heating roller, a pressing member pressing the inner side of the endless belt and an end pressing member to locally elastically deform the heating roller and provided downstream from the pressing member, wherein the toner comprises toner particles comprising a core containing a resin, a colorant and a releasing agent and a shell on, and the toner particles exhibiting an average of eight-point mean thickness of the shell of 100 to 300 nm and meeting a requirement of an average of Hmax/Hmin being less than 1.50, wherein Hmax is a maximum thickness of the shell and Hmin is a minimum thickness of the shell.

### TECHNICAL FIELD

The present invention relates to an image forming method of forming toner images through an electrophotographic system.

### TECHNICAL BACKGROUND

In electrophotographic image forming methods, there is broadly employed an image forming method in which as a method for fixing images, a recording medium bearing a toner image is allowed to pass between a heated roller and an opposed pressure roller to fix the toner image.

When the foregoing image forming method is applied to high-speed copiers, there is required an excessive increase of load to achieve sufficient heat supply, thickening the surface elastic layer or increasing a roller diameter. However, an increased load or a thickened surface elastic layer tends to make the pressing section less uniform, producing problems such as uneven fixing, image dislocation or paper crumpling. Increasing the roll diameter causes an apparatus to become larger and also produces problems such that the time necessary to bring the heating roll up to the fixing temperature becomes longer. To overcome such problems and also to realize a fixing method corresponding to an accelerated image forming method, there was proposed a fixing method of using a fixing device constituted of a heating roller and an endless belt which is brought into contact with the heating roller, while being pressed thereto (as described in, for example, JP-A Nos. 2-210480, 5-303300, 8-262903 and 2005-321462). Hereinafter, the term, JP-A refers to Japanese Patent Application Publication.

Recently, as a technique for reducing electric power consumption and making low-temperature fixing feasible from the point of view of taking global environment into consideration, there were proposed a toner into which a low-melting wax is incorporated by a process of polymerization, as described in JP-A 2000-321815 and a polymerization toner formed of a core of a low glass transition point and a shell of a high glass transition point, as described in JP-A No. 11-174732, which were difficult to be introduced in conventional pulverization methods.

However, using the above-described toners in a fixing device constituted of an endless belt as described above often causes image dislocation due to a low-melting wax or a resin of low glass transition point. Further, in a core/shell toner, the shell greatly affects fixing performance through balance of a thermal melting temperature and load pressure. Accordingly, since an increased shell thickness cannot achieve sufficient low-temperature fixing effects, non-uniform shell thickness vitiates electrostatic-charging properties, causing toner scattering or the like (as described in, for example, International Publication WO 98/25185 and JP-A Nos. 2004-191618 and 2004-271638).

### SUMMARY OF THE INVENTION

From the foregoing background, there is desired in toners having a core/shell structure, a technique for designing a toner of controlled shell thickness and uniformity.

The present invention has come into being in light of the above-mentioned problems. Thus, it is an object of the invention to provide an image forming method not causing image dislocation or toner scattering, while satisfying low-temperature fixability by using a core/shell structure toner with ensured heat storage stability in a fixing device constituted of an endless belt.

One aspect of the invention is directed to an image forming method comprising

forming a toner image through an electrophotographic System,

transferring the toner image onto a recording medium and

fixing the transferred toner image in a fixing device comprising a heating roller, an endless belt pressed into contact with the heating roller, a pressing member pressing the inner side of the endless belt and an end pressing member to locally elastically deform the heating roller and provided downstream from the pressing member, wherein a toner forming the toner image comprises a core containing at least a resin, a colorant and a releasing agent and having a shell on the surface of the core, the shell exhibits an eight-point mean thickness of 100 to 300 nm and meets the requirement of Hmax/Hmin being less than 1.50, wherein Hmax is a maximum thickness of the shell and Hmin is a minimum thickness of the shell.

### BRIEF EXPLANATION OF THE DRAWINGS

FIG. 1 illustrates a toner particle having a core/shell structure.

FIG. 2 illustrates a sectional view of an image forming apparatus in which toners relating to the invention are usable.

FIGS. 3(A) and 3(B) illustrate fixing devices usable in the invention.

### DETAILED DESCRIPTION OF THE INVENTION

Image dislocation in fixing which is regarded as a problem in the invention, refers to a distorted image due to collapse of a toner image, caused when a difference in rate between the recording paper and the heating roller is produced.

This phenomenon tends to occur in toner images containing a low melting wax (releasing agent) and/or a resin exhibiting a low glass transition point. The reason why such an adverse phenomenon is difficult to occur in the uniform core/shell structure of the invention is not clear but is assumed to be as below. In the case of a toner containing a low-melting wax, when formation of a core and a shell is incomplete, low-melting wax is locally absorbed into the recording paper, the toner image is easily shifted at the interface of the recording paper and the difference in rate between the recording paper and the heating roller causes partial nonuniform movement of the toner image. Similarly, in the case of a toner containing a resin exhibiting a low glass transition point, when formation of a core and a shell is incomplete, the resin of low glass transition point is eluted on the recording paper surface and the toner image is strongly fixed through an anchor effect onto the recording paper; on the contrary, fixing is weak in a low-eluted area. Such non-uniformity in fixing strength is assumed to cause image dislocation. It is predicted that this marked non-uniformity in elution occurs specifically in a fixing device having a structure of a heating roller being locally pressed to produce elastic deformation, and it is therefore contemplated that more marked image dislocation occurs.

There will be further described a preparation method or a fixing method of toners used in the invention, and an image forming method and an image forming apparatus by use thereof.

### Formation of Shell Layer

Specific methods for forming a uniform shell layer of toner particles, that is, factors controlling shell formation include (1) optimization of circularity degree of core particles in the shell formation, and (2) optimization of temperature conditions to perform shelling, i.e., core Tg+15° C.<shelling temperature<core Tsp, in which Tg and Tsp refer to glass transition point and softening point, respectively.

It is not clear why a thin and uniform shell layer is formed according to the means described above but regarding (1), it is assumed that a core particle having a higher circularity degree exhibits a reduced specific surface area and homogeneous surface property, so that resin particles to form a shell homogeneously adhere onto the core surface, whereby the core surface is efficiently covered with a small amount of shell. The circularity degree of the formed core particles is preferably as high as possible and preferably not less than 0.900. Since excessively raising the circularity degree lowers industrial productivity, the circularity degree of formed core particles is preferably in the range of from 0.911 to 0.930. A circularity degree falling within the range of 0.900 to 0.930 minimizes the difference in elution of a releasing agent, which depends on the shell thickness. Further, a circularity degree falling within such a range enhances offset resistance even when fixed at a temperature lower than the conventional fixing temperature and enables to avoid occurrence of winding. Further, homogeneous elution of a releasing agent contained in the core can achieve stable fixing. With regard to (2) described above, it is assumed that when shelling the core particle surface at a higher temperature than Tsp, shell components tend to bleed out on the surface during shell formation, rendering it difficult to form the shell, on the contrary, shell particles are not adhered onto the core surface at a temperature lower than Tg+15° C.

A shell thickness of not less than 100 nm ensures storage stability, while a shell thickness of not more than 300 nm exhibits low temperature fixability. A ratio of maximum shell thickness Hmax to minimum shell thickness Hmin (Hmax/Hmin) of not more than 1.50 can achieve storage stability and low-temperature fixability and results in superior electrostatic charge stability. Formed toner particles preferably exhibit a circularity degree of not less than 0.945. A circularity degree of not less than 0.945 can achieve compatibility of storage stability and low-temperature fixability and superior electrostatic charge stability. A circularity degree of not less than 0.960 is more preferred.

The reason for compatibility of heat resistance stability and low-temperature fixability and assurance of electrostatic-charging stability is not clear but is assumed to be as follows. A shell layer thickness of 100 nm is the lowest limit to prevent the internal core from being eluted onto the surface through compression due to the dead weight of the toner particle and a shell layer thickness of 300 nm is the highest limit to allow the internal core to be efficiently eluted when pressure is applied. With regard to the reason for electrostatic-charging stability, it is assumed that adjusting the shell thickness to a level specified in the invention reduces unevenness in shell thickness and contributes to more uniform electrostatic charge to the core, leading to uniform charge distribution on the toner particle surface and assurance of electrostatic charge.

In the image forming method of the invention, it is preferred to use toner particles meeting the following requirements:

Tg2−Tg1≧15° C., 20° C.≦Tg1≦40° C. and 40° C.≦Tg2

wherein Tg 1 is the glass transition point of the resin constituting the core and Tg 2 is the glass transition point of the resin constituting the shell.

In the toner particles of the invention, having a core/shell structure which comprise a core containing at least a resin and a colorant and a shell provided on the core surface, formation of a core/shell structure with a thin, relatively uniform shell layer enables to provide a toner achieving compatibility of low-temperature fixability and heat resistance stability and exhibiting stable charge properties.

It was discovered that a shell exhibiting an eight-point mean thickness of 100 to 300 nm and a ratio of maximum shell thickness to minimum shell thickness (Hmax/Hmin) of less than 1.50 enabled obtaining toner particles having a core/shell structure and achieved the targeted effects of the invention. Further, the invention made it feasible to specify a shell thickness through measurement thereof. The present invention is said to be the first one in which toner particles having relatively uniform shell thickness were found by measurement of shell thickness.

For instance, International Publication WO 98/25185 specifically disclosed values of shell thickness but these values were those which were calculated from the mass of shell constituents which were added in the toner preparation. Further, there is not found any description regarding determination of shell thickness by specific means or suggesting formation of a shell with a uniform thickness.

To realize the object of the invention, it is essential to form a thin and relatively uniform shell layer. It is considered that formation of a layer with relatively uniform thickness is preferred to ensure electrostatic-charging stability. However, it has been difficult to accomplish this and specifically, problems arose with the industrial application of the invention.

As a result of extensive studies by the inventors, it was proved that the shell thickness was required to be 100 to 300 nm in terms of heat resistance stability and low-temperature fixability of core particles exhibiting a low Tg and in the toner particles having an eight-point mean thickness of 100 to 300 nm, a ratio of maximum shell thickness Hmax to minimum shell thickness Hmin (Hmax/Hmin) of less than 1.50 resulted in improved electrostatic-charging stability, whereby the object of the invention was realized.

The toner relating to the invention achieves compatibility of low-temperature fixability and heat stability and ensures electrostatic-charging stability. Thus, it was found that when image formation was conducted using the toner relating to the invention, toner scattering in the printer or cracking of printed images is overcome and superior charge startup performance is achieved. The reason for achieving such charging stability is assumed to be that adjusting a shell thickness to a level specified in the invention reduces unevenness in shell thickness and contribution of electrostatic charge to the core becomes uniform, leading to uniform charge distribution on the toner particle surface and insurance of electrostatic charge.

There will be described definitions of physical characteristic values and their measurement methods. Further, explanations are given below with respect to preparation of toners, materials used for a toner and an image forming method and an image forming apparatus by using the prepared toner.

### Determination of Eight-point Mean Thickness

The shell thickness of the toner particles of the invention is determined by measurement of transmission electron micrographs of cross-sections of a toner particle. It can be sufficiently observed by using commonly known transmission electron microscopes, for example, LEM-2000 type (produced by TOPCON CORP.) and JEM-2000FX (produced by Nippon Denshi Co., Ltd.).

Specifically, after toner particles are sufficiently dispersed in a cold setting epoxy resin and embedded therein, and then dispersed in ca. 100 μm-sized styrene fine-powder and subjected to pressure shaping to form a block. The formed block is optionally dyed using triruthenium tetraoxide or further in combination with triosmium tetraoxide and then sliced by a microtome provided with a diamond cutter. Using a transmission electron microscope, a sample slice was photographed at a magnification until the section of a single particle comes into view (at approximately 10000 magnification) to obtain an electron micrograph.

Then, in the obtained electronmicrograph, the boundary at the interface between a core particle and a shell layer is clearly visible, while visually observing existence of a colorant or wax.

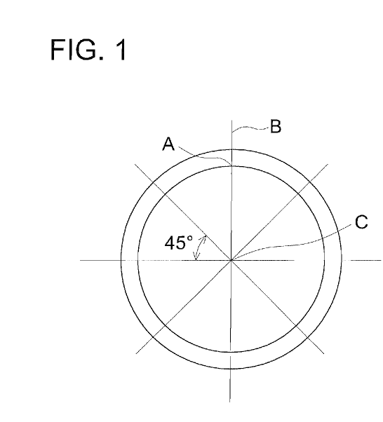

Next, as shown in FIG. 1, straight lines are drawn from the center of gravity of a toner particle toward the surface at intervals of 45°. The intersection of each of the straight lines with the core particle surface is designated as A and the intersection with the shell layer surface is designated as B. The distance between A and B (that is, shell thickness) is measured at eight points. The average of values at the eight points is defined as the shell layer thickness of a single toner particle.

In the invention, the eight-point mean thickness of shell layer of toner particles is represented by a mean value obtained when the eight-point mean thickness of the shell of a single toner particle is determined for 100 toner particles. Further, at least 80% by number of 100 toner particles is preferably accounted for by toner particles exhibiting an eight-point mean thickness of a shell of 100 to 300 nm.

In the invention, ratio (Hmax/Hmin) of the shell is determined using photographs of 100 toner particles, used in determination of the eight-point mean thickness of the shell.

Specifically, when straight lines are drawn from the center of gravity of a single toner particle toward the particle surface, the maximum shell layer thickness (Hmax) and the minimum shell layer thickness (Hmin) of the toner particle are determined to calculate the ratio (Hmax/Hmin). In the invention, the average Hmax/Hmin is represented by the average of Hmax/Hmin values for 100 toner particles.

In the invention, at least 80% by number of 100 toner particles is preferably accounted for by toner particles exhibiting an Hmax/Hmin of less than 1.50. When the minimum thickness of a shell layer is close to or is equal to zero, the layer thickness was determined to be 10 nm.

In the invention, the average of Hmax/Hmin is preferably not less than 1.05 and less than 1.50, and more preferably not less than 1.05 and less than 1.40.

### Shell Formation

To form a relatively uniform shell layer on the core exhibiting a low Tg are cited three means as described below. In the following, a resin constituting a core is denoted simply as core, in which expression “resin constituting” is abbreviated.

(1) The difference in Tg and the difference in softening point (SP) value between core and shell are increased.

When the glass transition point of the core is represented by Tg1 and the glass transition point of the shell is represented by Tg2, it is preferred to be in the range of Tg2−Tg1≧15° C., and more preferred to be Tg2−Tg1≧20° C.

When the solubility parameter of the core is represented by SP1 and the solubility parameter of the shell is represented by SP2, the difference between SP1 and SP2 (ΔSP) is preferably from 0.2 to 1.0, and more preferably from 0.25 to 0.95.

(2) After increasing the circularity degree of core particles, shell formation is performed. Thus, after core particles are increased to a circularity degree of 0.900 or more, shell formation is initiated.

(3) The shelling temperature is optimized.

Shell formation is performed preferably at a shelling temperature in the range of:

Tg of a core+20° C.< shelling temperature< Tsp of the core.

There will be further given descriptions regarding (1) to (3).

A solubility parameter value of a resin constituting a core or a shell layer of a toner particle can be determined by the composition of the resin. Thus, the parameter of a resin is calculated from solubility parameter(s) of monomer(s) constituting the resin and molar ratio of the monomer(s). For example, in a copolymer resin composed of monomers X and Y, solubility parameter (SP) of this copolymer resin is calculated according to the following equation (1):

SP={(x·SPx/Mx)+(y·SPy/My)}/C (1)

wherein x, Mx and SPx are a mass component ratio (mass %), molecular weight and solubility parameter of the monomer X, respectively, and y, My and Spy are those of the monomer Y, and C=x/Mx+y/My.

A solubility parameter of a monomer can be determined as follows. In the case when calculating a solubility parameter value (SP value) of a monomer, according to Fedors' proposal {Polym. Eng. Sci. 114, 114 (1974)}, an evaporation energy (Δ_{ci}) and a molar volume (Δᵥᵢ) are calculated and the solubility parameter is calculated according to the following equation (2):

σ=(ΣΔeⱼ/ΣΔvⱼ)^{1/2} (2)

provided that when a double bond is cleaved at the time of polymerization, the cleaved state is regarded as its molecular structure. Solubility parameter values of monomers are shown below, which are those calculated as described above.

| | |
|---|---|
| styrene | 10.55 |
| butyl acrylate | 9.77 |
| 2-ethylhexyl methacrylate | 9.04 |
| 2-ethylhexyl acrylate | 9.22 |
| methyl methacrylate | 9.93 |
| methacrylic acid | 12.54 |
| acrylic acid | 14.04 |

Using these values, a solubility parameter of a copolymer can be determined according to the foregoing equation (1). Solubility parameter values are also referred to, for example, J. Brandrup et al., POLYMER HANDBOOK 4th edition (Wiley- Interscience) and item, solubility parameter (http://polymer.nims.go.jp/guide/guide/p5110.html) described in data base, PolyInfo (http://polymer.nims.go.jp).

The solubility parameter value of a resin can be controlled by appropriate selection of the kind of monomers and their ratio. Preferably, the solubility parameter value is controlled by the content of an acidic monomer.

### Glass Transition Point Tg

The toner particles of the invention preferably satisfy the following requirement:

Tg2−Tg1≧15° C. and 20° C.≦Tg1≦40° C.

wherein Tg1 represents a glass transition point of resin A constituting a core and Tg2 represents a glass transition point of resin B constituting a shell.

The glass transition point of resin A constituting a core and that of resin B constituting a shell can be controlled by appropriate choice of the kind, amount and molecular weight of a polymerizable monomer forming a polymer. The glass transition point can be controlled, for example, in such a manner that polymerizable monomers for resin B constituting a shell layer and resin A constituting a core are each chosen from exemplified compounds as described later and the ratio and molecular weight of the respective monomers are adjusted so that the glass transition points of the monomers fall within the range described above. Exemplified compounds are those which demonstrate an achievement means, therefore, such compounds are not limited to these.

The glass transition point can be measured using DSC-7 differential scanning calorimeter (produced by Perkin-Elmer Corp.) or TAC7/DX thermal analysis controller (produced by Perkin-Elmer Corp.).

The measurement is conducted as follows. A toner of 4.5-5.0 mg is precisely weighed to two places of decimals, sealed into an aluminum pan (KIT NO. 0219-0041) and set into a DSC-7 sample holder. An empty aluminum pan is used as a reference. Temperature was controlled through heating-cooling-heating at a temperature-raising rate of 10° C./min and a temperature-lowering rate of 10° C./min in the range of 0 to 200° C. An extension line from the base-line prior to the initial rise of the first endothermic peak and a tangent line exhibiting the maximum slope between the initial rise and the peak are drawn and the intersection of both lines is defined as the glass transition point.

In the invention, the circularity degree is a value determined by using FPIA-2100 (produced by Sysmex Co., Ltd.). Core particles blend in an aqueous surfactant solution and dispersed using an ultrasonic homogenizer for 1 min. The measurement condition is set to HPF (high power focusing) mode and the measurement is carried out at an optimum concentration of the HPF detection number of 3000-10000. Reproducible data are obtained in such a range. The circularity degree is defined as below:

Circularity degree=(circumference length of a circle having an area equivalent to a projection of a particle)/(circumference length of a projection of a particle).

The average circularity degree is the sum of circularity degree values of total particles divided by the number of particles.

In the invention, a higher circularity degree of a formed core particle is preferred and specifically, a circularity degree of not more than 0.900 is preferred. A circularity degree of 0.900 or more makes it easy to form uniform shell thickness, as compared to a circularity degree of less than 0.900. However, an extremely high circularity degree results in lowering of industrial productivity. When taking other conditions into account, the average circularity degree of formed core particles is preferably in the range of 0.900 to 0.930.

In the invention, the difference of elution of a releasing agent, depending on thickness of the shell layer is minimized. Thus, when a circularity degree falls within a range of 0.900 to 0.930, superior offset resistance is achieved even when fixed at a lower temperature than a conventional fixing temperature and occurrence of winding can also be avoided, whereby a more stable fixing process is realized.

### Softening Point

There will be described measurement of the softening point of core particles in the invention.

Under an environment of 20±1° C. and 50±5% RH, 1.1 g of core particles are placed into a petri dish and leveled. After being allowed to stand for at least 12 hrs., they are compressed for 30 sec. under a force of 3820 kg/cm² using a molding device SSP-A (produced by Shimazu Seisakusho) to prepare a cylindrical molded sample of a diameter of 1 cm.

Using a flow tester CFT-500D (produced by Shimazu Seisakusho) under an environment of 24±5° C. and 50±20%, the prepared sample was extruded through a cylindrical die using a piston of 1 cm diameter after completion of pre-heating under conditions of a load weight of 196 N (29 kgF), at an initial temperature of 60° C., a pre-heating time of 300 sec. and temperature-raising rate of 6° C./min. An offset method temperature (T_{offset}), which is determined at an offset value of 5 mm in a melting temperature measurement method (temperature-raising method), is defined as a softening point in the invention. the T_{offset} refers to the temperature determined in the offset method.

In the toner of the invention, preferably, the core accounts for at lease 85% by mass and the shell accounts for 2 to 15% (more preferably 5 to 15%) by mass, based on the total mass of the toner.

### Toner Raw Materials

### (1) Binding Resin

Resin A forming a core portion and resin B forming a shell layer are preferably a styrene-acryl copolymer resin. As monomers to prepare a core-forming resin, it is preferred to allow a polymerizable monomer capable of raising a glass transition point (Tg) of a copolymer to be copolymerized, such as propyl acrylate, propyl methacrylate, butyl acrylate or 2-ethylhexylacrylate. As monomers to prepare a shell layer-forming resin, it is preferred to allow a polymerizable monomer capable of lowering a glass transition point (Tg) of a copolymer to be copolymerized, such as styrene, methyl methacrylate, or methacrylic acid.

There will be described resins constituting toners relating to the invention.

As resins used for a core or a shell of the toner of the invention are used polymers obtained by polymerization of polymerizable monomers, as described below. Thus, Resins relating to the invention contain, as a constituent, polymers obtained by polymerization of at least a polymerizable monomer. Examples of such a monomer include styrene, o-methylstyrene, m-methylstyrene, p-methylstyrene, α-methylstyrene, p-chlorostyrene, 3,4-dichlorostyrene, 3,4-dichlorostyrene, p-phenylstyrene, p-ethylstyrene, 2,4-dimethylstyrene, p-tert-butylstyrene, p-n-hexylstyrene, p-n-octylstyrene, p-n-nonylstyrene, p-n-decylstyrene, p-n-dodecylstyrene; methacrylic acid ester derivatives such as methyl methacrylate, ethyl methacrylate, n-butyl methacrylate, isopropyl methacrylate, isobutyl methacrylate, t-butyl methacrylate, n-octyl methacrylate, 2-ethyl methacrylate, stearyl methacrylate, lauryl methacrylate, phenyl methacrylate, diethylaminoethyl methacrylate, dimethylaminoethyl methacrylate; acrylic acid esters and derivatives thereof such as methyl acrylate, ethyl acrylate, isopropyl acrylate, n-butyl acrylate, t-butyl acrylate, isobutyl acrylate, n-octyl acrylate, 2-ethylhexyl acrylate, stearyl acrylate, lauryl acrylate, phenyl acrylate, and the like; olefins such as ethylene, propylene, isobutylene, and the like; halogen based vinyls such as vinyl chloride, vinylidene chloride, vinyl bromide, vinyl fluoride, and vinylidene fluoride; vinyl esters such as vinyl propionate, vinyl acetate, and vinyl benzoate; vinyl ethers such as vinyl methyl ether and vinyl ethyl ether; vinyl ketones such as vinyl methyl ketone, vinyl ethyl ketone, and vinyl hexyl ketone; N-vinyl compounds such as N-vinylcarbazole, N-vinylindole, and N-vinylpyrrolidone; vinyl compounds such as vinylnaphthalene and vinylpyridine; as well as derivatives of acrylic acid or methacrylic acid such as acrylonitrile, methacrylonitrile, and acryl amide. These vinyl based monomers may be employed individually or in combinations.

Further as polymerizable monomers, which constitute the resins, are preferably employed those having an ionic dissociating group in combination. Such monomers include, for example, those having substituents such as a carboxyl group, a sulfonic acid group, and a phosphoric acid group, as the constituting group of the monomers. Specifically listed are acrylic acid, methacrylic acid, maleic acid, itaconic acid, cinnamic acid, fumaric acid, maleic acid monoalkyl ester, itaconic acid monoalkyl ester, styrenesulfonic acid, allylsulfosuccinic acid, 2-acrylamido-2-methylpropanesulfonic acid, acid phosphoxyethyl methacrylate, 3-chloro-2-acid phosphoxyethyl methacrylate, and 3-chloro-2-acid phosphoxypropyl methacrylate.

Further, it is feasible to prepare resins having a cross-linking structure, employing polyfunctional vinyls such as divinylbenzene, ethylene glycol dimethacrylate, ethylene glycol diacrylate, diethylene glycol dimethacrylate, diethylene glycol diacrylate, triethylene glycol dimethacrylate, triethylene glycol diacrylate, neopentyl glycol methacrylate, and neopentyl glycol diacrylate.

### (2) Colorant

There are optionally employed as colorants used in the present invention, carbon black, magnetic materials, dyes, and pigments. Employed as carbon blacks are channel black, furnace black, acetylene black, thermal black, and lamp black. Employed as ferromagnetic materials may be ferromagnetic metals such as iron, nickel, cobalt, and the like, alloys comprising these metals, compounds of ferromagnetic metals such as ferrite and magnetite, alloys which comprise no ferromagnetic metals but exhibit ferromagnetism upon being thermally treated such as Heusler's alloys such as manganese-copper-aluminum, manganese-copper-tin, and the like, and chromium dioxide.

Examples of dyes include C.I. Solvent Red 1, the same 49, the same 52, the same 63, the same 111, the same 122, C.I. Solvent Yellow 19, the same 44, the same 77, the same 79, the same 81, the same 82, the same 93, the same 98, the same 103, the same 104, the same 112, the same 162, C.I. Solvent Blue 25, the same 36, the same 60, the same 70, the same 93, the same 95, and the like, and further mixtures thereof may also be employed. There may be employed, as pigments, C.I. Pigment Red 5, the same 48:1, the same 53:1, the same 57:1, the same 122, the same 139, the same 144, the same 149, the same 166, the same 177, the same 178, the same 222, C.I. Pigment Orange 31, the same 43, C.I. Pigment Yellow 14, the same 17, the same 93, the same 94, the same 138, C.I. Pigment Green 7, C.I. Pigment Blue 15:3, and the same 60, and mixtures thereof may be employed. The number average primary particle diameter varies widely depending on their types, but is preferably between about 10 and about 200 nm.

There may be added colorants in the stage of coagulating polymer particles with coagulants, whereby colored particles are prepared.

### (3) Wax (Releasing Agent)

Waxes usable in the toner of the invention are those known in the art. Examples thereof include polyolefin wax such as polyethylene wax and polypropylene wax; long chain hydrocarbon wax such as paraffin wax and sasol wax; dialkylketone type wax such as distearylketone; ester type wax such as carnauba wax, montan wax, trimethylolpropane tribehenate, pentaerythritol tetramyristate, pentaerythritol tetrabehenate, pentaerythritol diacetate dibehenate, glycerin tribehenate, 1,18-octadecanediol distearate, trimellitic acid tristarate, and distearyl meleate; and amide type wax such as ethylenediamine dibehenylamide and trimellitic acid tristearylamide.

The melting point of a wax usable in the invention is preferably 40 to 160° C., more preferably 50 to 120° C., and still more preferably 60 to 90° C. A melting point falling within the foregoing range ensures heat stability of toners and can achieve stable toner image formation without causing cold offsetting even when fixed at a relatively low temperature. The wax content of the toner is preferably in the range of 1% to 30% by mass, and more preferably 5% to 20%.

There will be described polymerization initiators, chain transfer agents and surfactants for use in the preparation of toners, as described above.

### (4) Radical Polymerization Initiator

Resin constituting the core and the shell of toner particles relating to the invention can be prepared by polymerization of polymerizable monomers. Radical polymerization initiators usable in the invention are those described below. Specifically, when forming resin particles through emulsion polymerization, oil-soluble polymerization initiators are usable. Examples of an oil-soluble polymerization initiator include azo- or diazo-type polymerization initiators, e.g., 2,2′-azobis-(2,4-dimethylvaleronitrile), 2,2′-azobisisobutylonitrile, 1,1′-azobis(cyclohexane-1-carbonitrile), 2,2′-azobis-4-methoxy-2,4-dimethylvaleronitrile, azobisisobutylonitrile; peroxide type polymerization initiators, e.g., benzoyl peroxide, methyl ethyl ketone peroxide, diisopropylperoxycarbonate, cumene hydroperoxide, t-butyl hyroperoxide, di-t-butyl peroxidedicumyl peroxide, 2,4-dichlorobenzoyl peroxide, lauroyl peroxide, 2,2-bis-(4,4-t-butylperoxycyclohexyl)-propane, tris-(t-butylperoxy)triazine; and polymeric initiators having a side-chain of peroxide.

Water-soluble radical polymerization initiators are usable when forming particulate resin through emulsion polymerization. Examples of a water-soluble polymerization initiator include persulfates such as potassium persulfate and ammonium persulfate; azobisaminodipropane acetic acid salt, azobiscyanovaleric acid and its salt, and hydrogen peroxide.

Conventionally used chain-transfer agents are usable for the purpose of adjustment of the molecular weight of resin constituting composite resin particles. Chain-transfer agents are not specifically limited and examples thereof include mercaptans such as octylmercaptan, dodecylmercaptan and tert-dodecylmercaptan; n-octyl-3-mercaptopropionic acid ester; terpinolene; carbon tetrabromide and α-methylstyrene dimmer.

### (5) Dispersion Stabilizer

Dispersion stabilizers are also usable for moderate dispersion of polymerizable monomers in a reaction system. Examples of a dispersion stabilizer include calcium phosphate, magnesium phosphate, zinc phosphate, aluminum phosphate, calcium carbonate, magnesium carbonate, calcium hydroxide, magnesium hydroxide, aluminum hydroxide, calcium metasilicate, calcium sulfate, barium sulfate, bentonite, silica and alumina. Further, polyvinyl alcohol, gelatin, methylcellulose, sodium dodecybenzenesulfate, ethylene oxide adduct, sodium higher alcohol-sulfate and the like, which are generally usable as a surfactant, are also usable as a dispersion stabilizer.

Surfactant usable in the invention are described as follows.

To perform polymerization using radical-polymerizable monomers, surfactants are used to disperse such monomers in the form of oil droplets in an aqueous medium. Surfactants usable therein are not specifically limited but ionic surfactants described below are preferred. Such ionic surfactants include sulfates (e.g., sodium dodecylbenzenesulfate, sodium arylalkylpolyethersulfonate, sodium 3,3-disulfondisphenylurea-4,4-diazo-bis-amino-8-naphthol-6-sulfonate, ortho-carboxybenzene-azo-dimethylaniline, sodium 2,2,5,5-tetramethyl-triphenylmethane-4,4-diazo-bis-β-naphthol-6-sulfonate) and carboxylates (e.g., sodium oleate, sodium laurate, sodium caprate, sodium caprylate, sodium caproate, potassium stearate, calcium oleate).

Nonionic surfactants are also usable. Examples thereof include polyethylene oxide, polypropylene oxide, a combination of polypropylene oxide and polyethylene oxide, an ester of polyethylene glycol and a higher fatty acid, alkylphenol polyethylene oxide, an ester of polypropylene oxide and a higher fatty acid, and sorbitan ester.

Next, there will be described preparation methods of a toner used for developing electrostatic images.

The toner is prepared via the following steps:

(1) dissolution/dispersion step of dissolving and/or dispersing a radical-polymerizable monomer,
(2) polymerization step of preparing resin microparticles,
(3) coagulation/fusion step of allowing resin microparticle and colorant particles to coagulate and fuse to form core particles (associated particles),
(4) first ripening step of ripening the associated particles with heat energy to control the particle form,
(5) shelling step of adding particulate resin used for a shell to a dispersion of the core particles (associated particles) to allow the resin used for a shell to be coagulated and fused onto the surface of the core particles to form colored particles exhibiting a core/shell structure,
(6) second ripening step for ripening the colored particles of a core/shell structure with heat energy to control the form of the colored particles,
(7) washing step of separating the colored particles from a cooled dispersion of colored particles to remove surfactants and the like from the colored particles;
(8) drying step of the washed colored particles, and optionally
(9) a step of adding external additives to the dried colored particles.

In the preparation of the toner of the invention, firstly, resin microparticles and colorant particles are coagulated with each other and fused to form colored particles as core particles. Then, particulate resin is added to a dispersion of the core particles to allow the particulate resin to coagulate and fuse onto the surface of the core particles to form colored particles having a core/shell structure. Thus, the toner particles of the invention are prepared by adding particulate resin to a dispersion of core particles prepared by various methods to be fused onto the core particles to form toner particles of a core/shell structure.

One feature of the toner relating to the invention is that toner particles have a thin shell layer with relatively uniform thickness, and therefore, after shell formation, the toner particles preferably are those with a small size and a uniform shape. To form toner particles having such a structure and a shape, it is preferred that core particles are made as uniform a size and a shape as possible, followed by shell formation with adding particulate resin for the shell. Shape control of the final toner particles is preferably performed during the shelling stage to provide the optimal shape. It is therefore essential to form core particles with uniform size and shape. A particulate resin is uniformly adhered to the surface of such toner particles, leading to formation of toner particles with uniform shell thickness.

Cores of the toner particles are prepared by coagulation and fusion of resin microparticles and colorant particles. The shape of core particles is controlled by adjusting the heating temperature in the coagulation/fusion step and the heating temperature and time in the first ripening step. Of the foregoing, time control of the first ripening step is most effective. The ripening step aims to control the circularity degree of associated particles and the associated particles become a shape close to a circle upon prolonging the ripening step.

The core portion of toner particles is formed preferably as follows. A releasing agent component is dissolved or dispersed in a polymerizable monomer to form resin (A) and then mechanically dispersed in an aqueous medium to polymerize the monomer through mini-emulsion polymerization to form composite resin microparticles. The thus formed resin microparticles and colorant particles are subjected to salting-out (or coagulation)/fusion. When dissolving a releasing agent component in a monomer, the releasing agent component may be dissolved through dissolution or melting.

There will be described the respective steps in the preparation of toners relating to the invention.

### (1) Dissolution/Dispersion Step:

In this step, a releasing agent compound is dissolved in a radical-polymerizable monomer to prepare a monomer solution containing a releasing agent.

### (2) Polymerization Step:

In one preferred embodiment of this step, wax is added to an aqueous medium containing a surfactant at a concentration less than the critical micelle concentration (CMC) to form droplets, while providing mechanical energy. Subsequently, a water-soluble radical polymerization initiator is added thereto to promote polymerization within the droplets. An oil-soluble polymerization initiator may be contained in the droplets. In the polymerization step, providing mechanical energy is needed to perform enforced emulsification to form droplets. Means for providing mechanical energy include those for providing strong stirring or ultrasonic energy, for example, a homomixer, an ultrasonic homogenizer or a Manton-Gaulin homomixer.

Resin microparticies containing a binding resin and a wax are obtained in the polymerization step. The resin microparticles may be colored microparticles or non-colored ones. Colored microparticles can be obtained by polymerization of a monomer composition containing a colorant. In the case when using non-colored microparticles, in the coagulation/fusion step, a dispersion of colorant particles is added to a dispersion of resin microparticles to allow the resin microparticles and the colorant particles to be fused to obtain colored particles.

### (3) Coagulation/Fusion Step:

A method for coagulation and fusion in the fusion step preferably is salting-out/fusion of resin microparticles (colored or non-colored resin microparticles) obtained in the above-described polymerization step. In the coagulation/fusion step, a particulate internal additive such as a releasing agent or a charge-controlling agent may be coagulated/fused together with resin microparticles and colorant particles.

The salting-out/fusion means that coagulation and fusion are concurrently promoted and when grown to an intended particle size, a coagulation-terminating agent is added thereto to stop growth of the particles and heating optionally continues to control the particle shape.

The aqueous medium used in the coagulation/fusion step refers to a medium that is mainly composed of water (at 50% by weight or more). A component other than water is a water-soluble organic solvent. Examples thereof include methanol, ethanol, isopropanol, butanol, acetone, methyl ethyl ketone and tetrahydrofuran.

The colorant particles can be prepared by dispersing a colorant in an aqueous medium. Thus, a colorant is dispersed in an aqueous medium containing surfactants at a concentration in water at least the critical micelle concentration (CMC). Dispersing machines used for dispersing the colorant are not specifically limited but preferably pressure dispersing machines such as an ultrasonic disperser, a mechanical homogenizer, a Manton-Gaulin homomixer or a pressure homogenizer, and a medium type dispersing machines such as a sand grinder, a Gettsman mil or a diamond fine mill. Usable surfactants include those described later. The colorant particles may be those which have been subjected to surface modification treatments. Surface modification of the colorant particles is affected, for example, in the following manner. A colorant is dispersed in a solvent and thereto, a surface-modifying agent is added and allowed to react with heating. After completion of the reaction, the colorant is filtered off, washed with the same solvent and dried to produce a surface-modified colorant (pigment).

The process of salting-out/fusion as a preferred method of coagulation/fusion is conducted, for example, in the following manner. To water containing resin microparticles and colorant particles is added an agent for salting out (hereinafter, also denoted as salting out agent), e.g., alkali metal salts, alkaline earth metal salts or trivalent metal salts, at a concentration higher than the critical coagulation concentration. Subsequently, the mixture is heated at a temperature (° C.) higher than the glass transition temperature of the resin microparticles and also higher than the melting peak temperature to promote fusion concurrently with salting out. Of alkali metal salts and alkaline earth metal salts, alkali metals include, for example, lithium, potassium and sodium; and alkaline earth metals include magnesium calcium, strontium, and barium, of which potassium, sodium, magnesium, calcium and barium are preferred.

When performing coagulation and fusion through salting out and fusion, the mixture after adding a salting-out agent is permitted to stand preferably as short a time as possible. The reason therefor is not totally clear but there were produced problems such that the coagulation state of particles varied, the particle size distribution became unstable or the surface property of fused toner particles varied, depending on the standing time after being salted out. Addition of a salting-out agent needs to be conducted at a temperature lower than the glass transition temperature of the resin microparticles. The reason therefor is that addition of a salting-out agent at a temperature higher than the glass transition temperature promotes salting out and fusion of the resin microparticles but cannot control the particle size, resulting in formation of larger sized particles. The addition temperature, which is lower than the glass transition temperature, is usually in the range of 5 to 55° C., and preferably 10 to 45° C.

A salting-out agent is added at a temperature lower than the glass transition temperature of the resin microparticles and subsequently, the temperature is promptly increased to a temperature higher than the glass transition temperature of the resin microparticles and also higher than the melting peak temperature (° C.) of the mixture. The temperature is increased preferably over a period of less than 1 hr. The temperature needs to be promptly increased, preferably at a rate of 0.25° C./min or more. The upper temperature limit is not definite but instantaneously increasing the temperature abruptly causes salting out, rendering it difficult to control the particle size. The temperature is increased preferably at a rate of 5° C./min or less. In the fusion step, resin microparticles and any other particles are subjected to salting-out/fusion to obtain a dispersion of associated particles (core particles).

### (4) First Ripening Step:

In the invention, the heating temperature in the coagulation/fusion step and the heating temperature and time in the first ripening step is so controlled that the formed core particles are in the shape of being rugged. Concretely, the coagulation/fusion step is conducted at a relatively low heating temperature to retard the progress of resin particles being fused to each other, which promotes deformation, or the first ripening is controlled at a low heating temperature for a long period so that the formed core particles are in the form of being relatively uniform.

### (5) Shelling Step:

In the shelling step, a dispersion of a particulate resin to be used for shelling is added to a dispersion of core particles and the resin particles for shelling coagulate and fuse with each other to permit the particulate resin to cover the surface of core particles, resulting in formation of colored particles. Specifically, a core particle dispersion is added to a dispersion of resin particles for shelling, while maintaining the temperature in the coagulation/fusion step and the first ripening step and stirring with heating further continues for several hours, while the resin particles are permitted to cover the core particle surface to form colored particles. The time for stirring with heating is preferably 1 to 7 hrs., and more preferably 3 to 5 hrs. The shelling temperature is preferably in the range of 35 to 98° C.

### (6) Second Ripening Step:

When the colored particles reach the prescribed size through shelling, a stopping agent such as sodium chloride is added thereto to stop growth of particles. Thereafter, stirring with heating continues further for several hours to permit the resin particles to fuse onto the core particles. In the shelling step, a 10 to 500 nm thick shell is formed on the core particle surface. Thus, resin particles are fixed by melting together onto the core particle surface to form a shell, whereby round, uniform colored particles are formed. Further, the shape of colored particles can be controlled to be close to a sphere by extending the second ripening time or by raising the ripening temperature.

### Cooling, Solid-Liquid Separation and Washing Step:

This step refers to a stage that subjects a dispersion of the foregoing colored particles to a cooling treatment (rapid cooling). Cooling is performed at a cooling rate of 1 to 20° C./min. The cooling treatment is not specifically limited and examples thereof include a method in which a refrigerant is introduced from the exterior of the reaction vessel to perform cooling and a method in which chilled water is directly supplied to the reaction system to perform cooling.

In the solid-liquid separation and washing step, a solid-liquid separation treatment of separating colored particles from a colored particle dispersion is conducted, then cooled to the prescribed temperature in the foregoing step and a washing treatment for removing adhered material such as a surfactant or salting-out agent from a separated toner cake (wetted aggregate of colored particles aggregated in a cake form) is applied. In this step, a filtration treatment is conducted, for example, by a centrifugal separation, filtration under reduced pressure using a Nutsche funnel or filtration using a filter press, but is not specifically limited.

### Drying Step:

In this step, the washed toner cake is subjected to a drying treatment to obtain dried colored particles. Drying machines usable in this step include, for example, a spray dryer, a vacuum freeze-drying machine, or a vacuum dryer. Preferably used are a standing plate type dryer, a movable plate type dryer, a fluidized-bed dryer, a rotary dryer or a stirring dryer. The moisture content of the dried colored particles is preferably not more than 5% by weight, and more preferably not more than 2%. When colored particles that were subjected to a drying treatment are aggregated via a weak attractive force between particles, the aggregate may be subjected to a pulverization treatment. Pulverization can be conducted using a mechanical pulverizing device such as a jet mill, Henschel mixer, coffee mill or food processor.

### External Addition Treatment:

In this step, the dried colored particles are optionally mixed with external additives to prepare a toner. There are usable mechanical mixers such as a Henschel mixer and a coffee mill.

The mass average particle size (dispersion particle size) of composite resin particles is preferably in the range of 10 to 1000 nm, and more preferably 30 to 300 nm. The mass average particle size is a value determined an electrophoretic light scattering photometer ELS-800 (produced by Otsuka Denshi Co., Ltd.).

### Image Forming Method and Apparatus

The toner relating to the invention may be used as a single-component developer or a two-component developer, but is used preferably as a two-component developer.

Next, there will be described an image forming method in which the toner relating to the invention is usable. The toner relating to the invention is used in high-speed image forming apparatuses, for example, at a level of a printing rate of 300 to 400 mm/sec (corresponding to output performance of 56 to 85 sheet/min in A4 size sheet). Specifically, there are cited on-demand printers capable of preparing a large amount of documents for a short period. The invention is also applicable to image forming methods in which the fixing roller temperature is not more than 150° C. (preferably not more than 130° C.) and not less than 100° C. This is assumed to be due to the fact that in the toner of the invention the core is covered with a thin shell layer, which exhibits sufficient durability and enables to complete fixing for a short period.

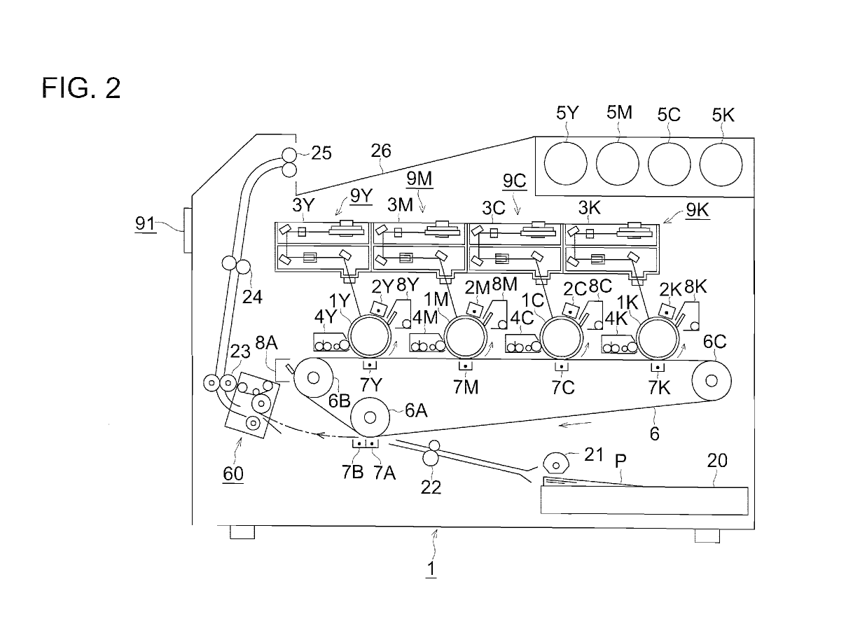

FIG. 2 illustrates one of image forming apparatuses in which toners relating to the invention are usable, and showing the sectional view.

As shown in FIG. 2, this image forming apparatus 1 is called a tandem color image forming apparatus, which is, as a main constitution, comprised of plural image forming units 9Y, 9M, 9C and 9K, a intermediate transfer body 6, a conveyance means, toner cartridges 5Y, 5M, 5C and 5K, a fixing device 60 of the invention and operation section 91.

The image forming unit 9Y forming yellow images comprises an image bearing body (hereinafter, also denoted as photoreceptor) 1Y, a charging means 2Y, an exposure means 3Y, a development means 4Y, a transfer means 7Y and a cleaning means 8Y.

The image forming unit 9Y forming magenta images comprises a photoreceptor 1M, a charging means 2M, an exposure means 3M, a development means 4M, a transfer means 7Y and a cleaning means 8M.

The image forming unit 9Y forming cyan images comprises a photoreceptor 1C, a charging means 2C, an exposure means 3C, a development means 4C, a transfer means 7C and a cleaning means 8C.

The image forming unit 9K forming black images comprises a photoreceptor 1K, a charging means 2K, an exposure means 3K, a development means 4K, a transfer means 7K and a cleaning means 8K.

The intermediate transfer body 6 is turned by rollers 6A, 6E, 6C, while being pivotably supported.

The color images formed by the image forming units 9Y, 9M, 9C and 9K are each successively primarily transferred onto the pivoting intermediate transfer body 6 synthesized to form a synthesized color image.

Transfer paper P of paper or the like, as a final transfer material housed in paper feed cassette 20, is fed by paper feed roller 21 and conveyed to a transfer means 7A and 7B through a resist roller 22A, 22B, 22C and 22D and resist roller 23, and color images are secondarily transferred together on recording member P.

The color image-transferred recording member (P) is fixed by a fixing device 60, nipped by paper discharge roller 25 and put through conveyance rollers 23 and 24 onto paper discharge tray 26 outside a machine.

### Fixing Device

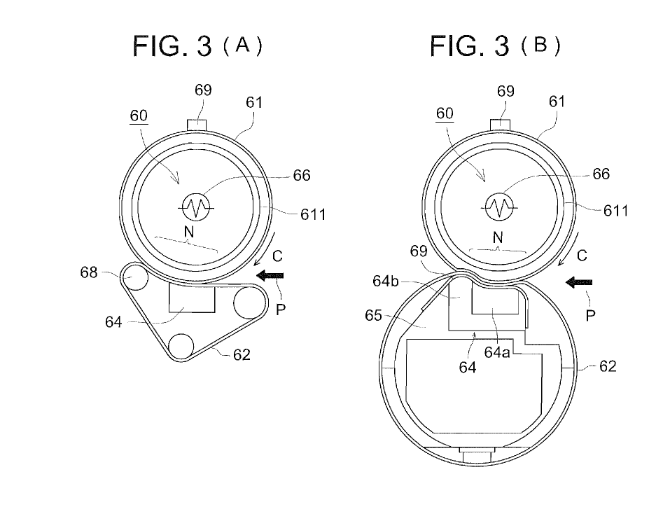

Next, a fixing device 60 used in the image forming apparatus will be described. FIGS. 3A and 3B each illustrate a sectional side view of the fixing device 60. The fixing device 60 comprises, as main constituents, a heating roller 61 as a pivoting member, an endless belt as a belt member and a pressing member 64 as a pressure member which is pressed by the heating roller 61 through the endless belt 62.

The heating roller 61 is a cylindrical roller which is comprised of a heat-resistant elastomer layer and releasing layer which are provided around a metal core (cylindrical core), and the heating roller is pivotably supported and rotates at a circumferential speed of 194 mm/sec.

There is disposed, as a heating source, a 600W rated halogen heater in the interior of the heating roller 61. There is also disposed a temperature detector 69 which is in contact with the surface of the heating roller 61. The control section of the image forming apparatus controls lighting of the halogen heater 66, based on temperature-measured values by the temperature detector 69 so that the surface temperature of the heating roller 61 is maintained at a prescribed temperature (for example, 175° C.).

The endless belt 62, which is a seamless belt, is pivotably supported by a pressing member 64 which is disposed in the inner side of the endless belt 62, a belt guide member and edge guide members which are disposed on both sides of the endless belt 62. The endless belt is arranged so as to be pressed into contact with the heating roller 61 to form a nip section N and pivots at a moving speed of 194 mm/sec, while being driven by the heating roller 61.

The pressing member 64 is disposed in the inner side of the endless belt 62, while being pressed against the heating roller 61 through the endless belt 62, forming the nip section N between the pressing member and the heating roller. As shown in FIG. 3(B), a pressing member 64 is disposed in the inner side of the endless belt 62, while being pressed to the heating roller 61 through the endless belt 62, forming the nip section N between the pressing member and the heating roller. The pressing member 64 forms a pre-nip section 64a to ensure a broad nip section P at the inlet side (upstream side) of the nip section N. Further, an release-pressing member 64b is disposed in the outlet side (downstream side) of the nip section N, which locally presses the surface of the heating roller 61 smoothens the toner image surface to provide image gloss and simultaneously provides deformation (recess) onto the surface of the heating roller 61 to form down-curl of the transfer paper P. Further, to reduce slide resistance between the inner circumferential surface of the endless belt 62 and the pressing member 64, the pressing member is provided with a low-frictional sheet 69 as a slide member on the surface in contact with the endless belt 62. The pressing member 64 and the low-frictional sheet 69 are supported by a metal holder 65.

The heating roller 61 is connected to a driving motor not shown in the figure and rotates in an arrow direction C and while being driven by this rotation, the endless belt 62 turns in the same direction as the heating roller 61. In the secondary transfer section of the image forming apparatus shown in FIG. 1, the transfer paper P onto which a toner image is transferred is guided by a fix-inlet guide and conveyed to the nip section. When the transfer paper P passes through the nip section N, the toner image on the paper P is fixed by pressure applied to the nip section N and heat supplied from the heating roller 61. In the fixing device 60, recessed pre-nip member following the outer circumferential surface broadens the nip section N, whereby more stable fixing performance is maintained.

Further, in the vicinity of the downstream side of the nip section N, an auxiliary member for peeling is disposed, which separates the transfer paper P peeled from the heating roller 61 by the end pressing member 68 and introduces it to a discharge passage directed toward the discharge section of the image forming apparatus. The auxiliary member for peeling is held by a baffle holder, while a peeling baffle being close to the heating roller 61 with opposing the rotating direction (in the counter direction) of the heating roller 61.

Next, there will be described members constituting the fixing device 60. In the heating roller 61, a core (base material) 611 is constituted of a cylinder having an outer diameter of 30 mm, a thickness of 1.8 mm and a length of 360 mm which is composed of a high heat-conductive metal such as iron, aluminum or SUS (stainless steel). A heat-resistant elastomer layer is composed of a highly heat-resistant elastic material. Specifically, there are preferred elastic materials such as rubber exhibiting a rubber hardness of 15-45° (JIS-A) and elastomers. Examples thereof include silicone rubber and fluorinated rubber. In the fixing device 60, silicone HTV rubber exhibiting a rubber hardness of 35° (JIS-A) covers the core 611 in a thickness of 600 μm.

The releasing layer uses heat-resistant resin, for example, silicone resin and fluorinated resin but fluorinated resin is suitable in terms of pealability from a toner and abrasion resistance. Specific examples of fluorinated resin include a copolymer of tetrafluoroethylene and perfluoroalkyl vinyl ether (PFA), polytetrafluoroethylene (PTFE) and a copolymer of tetrafluoroethylene and hexafluoropropylene (FEP). The thickness of a pealing layer is preferably 5 to 30 nm. The fixing device 60 is covered with a 30 μm thick PFA and fined to the state close to the mirror surface.

The endless belt 62, the prototype of which is a cylindrically-formed seamless belt so as to prevent adverse effects due to a seam, is comprised of a base layer and a releasing layer covering the surface of side of the heating roller 61 or both surfaces. The base layer is composed of polymers such as a thermosetting polyimide, a thermoplastic polyimide, a polyamide and a polyamideimide, and having a thickness of 30 to 200 μm, preferably 50 to 125 μm and more preferably 75 to 100 μm. The releasing layer which covers the surface of the base layer is formed of a fluorinated resin such as PFA, PTFE and FEP, and having a thickness of 5 to 100 μm, and preferably 10 to 30 μm. In the fixing device 60, there is used the endless belt 66 which is comprised of a base layer of a thermosetting polyimide, having a peripheral length of 94 mm, a thickness of 75 μm and a width of 320 mm, and further on the base layer, a 30 μm thick releasing layer comprised of PFA.

The pressing member 64 which is disposed in the inside of the endless belt 62 is constituted of a pre-nip member and an end pressing member and is secured by a holder so as to press against heating roller 61 at a load of 350 N. Elastomers such as silicone rubber or fluorinated rubber or a plate spring is used for the pre-nip member, so that the surface on a portion of the heating roller 61 is formed of a recessed curved-surface following the circumferential surface of the heating roller 61. In the fixing device 60 is used a 10 mm wide, 5 mm thick, 320 long silicone rubber.

The end-pressing member is formed of a heat-resistant resin such as PPS (polyphenylene sulfide), polyimide, polyester or polyamide, or a metal such as iron, aluminum or SUS (stainless steel). In the end-pressing member, the outer surface forming the nip section N is a protruded curved-surface of a given radius of curvature. In the fixing device 60, the endless belt 62 is wrapped by the pressing member 64 onto the heating roller 61 at a wrapping angle of approximately 60° to form the nip section N of a 10 mm width.

Further, the fixing device 60 is longitudinally provided with a lubricant-coating member. The lubricant-coating member is disposed so as to be in contact with the inner peripheral surface of the endless belt 62, and is supplies with an optimum amount of lubricant. Thus, a lubricant is supplied to the sliding portion between the endless belt 62 and a low-friction sheet, thereby reducing slide resistance between the pressing member 64 and the endless belt 62 via the low-frictional sheet and enables smoothly rotation of the endless belt 62. Further, abrasion to the inner periphery of the endless belt 62 and the low-friction sheet surface are effectively inhibited.

Suitable lubricants are those which exhibit long durability under an environment of a fixing temperature and can maintain wettability to the inner periphery of the endless belt 62. Such lubricants include, for example, liquid oils such as silicone oil and fluorinated oil, a grease of a mixture of solid material and liquid and their combination Specific examples of silicone oil include dimethylsilicone oil, methylphenylsilicone oil, amino-modified silicone oil, carboxy-modified silicone oil, silanol-modified silicone oil and sulfonic acid-modified silicone oil. Used in the fixing device 60 is methylphenylsilicone oil (KF53, produced by Shinetsu Kagaku Co., Ltd.).

### Transfer Material (Transfer Paper)

Transfer material P used in the invention is a support holding toner images and is one which is usually called an image support, recording material or transfer paper. Specific examples thereof include plain paper or fine-quality paper including thin paper and heavy paper, coated paper for graphic art such as art paper or coated paper, commercially available Japanese paper and post card paper and various kinds of transfer materials such as plastic film for OHP and cloth.

### EXAMPLES

The embodiments of the invention are further described with reference to examples but the invention should not be construed to be limited to these. Unless specifically noted, “part(s)” represents parts by mass.

### Preparation of Core Resin Particle

### Core Resin Particle 1

As described below, the 1st polymerization step, the 2nd polymerization step and the 3rd polymerization step were successively carried out to prepare resin particles 1 used for forming a core (hereinafter, denoted as core resin particle 1).

(1) 1st Polymerization Step:

To a 5 L reaction vessel provided with a stirrer, a temperature sensor, condenser tube and nitrogen introducing device, 4 parts of an anionic surfactant (formula 1) was dissolved in 3040 parts of deionized water and heated to 80° C., while stirring at a rate of 230 rpm in a stream of nitrogen.

C₁₀H₂₁(OCH₂ CH₂)₂SO₃Na formula 1

To the foregoing surfactant solution, an initiator solution of 10 g of a polymerization initiator (potassium persulfate:KPS) dissolved in 400 parts of deionized water was added and raised to a temperature of 75° C. and then, a monomer mixture comprised of 532 parts of styrene, 200 parts of n-butyl acrylate, 68 parts of acrylic acid and 16.4 parts of n-octylmercaptan was dropwise added over a period of 1 hr. The mixture was heated at 75° C. for 2 hr with stirring to undergo polymerization (1st polymerization step) to obtain resin particles. This was designated “resin particle A1”. The obtained resin particle A1 exhibited a mass average molecular weight (Mw) of 16,000.

(2) 2nd Polymerization Step (Formation of Interlayer):

To a flask equipped with a stirrer containing a monomer mixture of 101,1 parts of styrene, 62.2 parts of n-butylacrylate, 12.3 parts of methacrylic acid and 1.75 parts of n-octylmercaptan was added 93.8 parts of paraffin wax HNP-57 (produced by Nippon Seiro Co.) and dissolved with heating at 90° C. to obtain a monomer solution.

Further, 3 parts of an anionic surfactant (formula 1) was dissolved in 1560 ml of deionized water and heated at 98° C. To this surfactant solution, a dispersion of resin particle A1 was added in amount of 32.8 g solids (i.e., represented by equivalent converted to solids) and dispersed for 8 hr. using a mechanical stirrer having a circulating path (CLEAR MIX, M Technique Co., Ltd.) to obtain a dispersion (emulsion) containing emulsion particles having a dispersed particle size of 340 nm.

Subsequently, to this dispersion was added an initiator solution of 6 parts of potassium persulfate dissolved in 200 parts of deionized water and was heated at 98° C. for 12 hrs. with stirring to undergo polymerization (2nd polymerization step) to obtain resin particles. The thus obtained resin particles were designated “resin particle A”. The Mw of the resin particle A″ prepared in the 2nd polymerization step was 23,000.

(3) 3rd Polymerization Step (Formation of Outer Layer):

To the thus obtained resin particle A2 was added an initiator solution of 5.45 g of potassium persulfate dissolved in 220 parts of deionized water and further thereto, a monomer mixture of 293.8 parts of styrene, 154.1 parts of n-butyl acrylate and 7.08 parts of n-octylmercaptan was dropwise added over 1 hr. After completing addition, stirring continued for 2 hrs. with heating to undergo polymerization (3rd polymerization step). Then the reaction mixture was cooled to 28° C. to obtain “core resin particle 1”. The Mw of “resin particle A3” prepared in the 3rd polymerization was 26,800.

The volume average particle size of composite resin particles constituting the core resin particle 1 was 125 nm, which was determined by using MICROTRAC UPA-150 produced by HONEYWELL Ci.). The core resin particle 1 exhibited a glass transition point (Tg) of 28.1° C. and a solubility parameter (SP value) of 10.09.

### Core Resin Particle 6

“Core resin particle 6” was prepared similarly to the foregoing core resin particle 3, except that in the 2nd polymerization step (outer layer formation), the monomer mixture was replaced by a mixture of 202.5 parts of styrene, 211.5 parts of n-butyl acrylate, 36 parts of methacrylic acid and 5.2 parts of n-octylmercaptan, and the initiator solution was replaced by an initiator solution of 5.1 parts of potassium persulfate dissolved in 197 parts of deionized water.

### Core Resin Particle 7

“Core resin particle 7” was prepared similarly to the foregoing core resin particle 3, except that in the 1st polymerization step (inner layer formation), the monomer mixture was replaced by a mixture 115.9 parts of styrene, 47.4 parts of n-butyl acrylate, 12.3 parts of methacrylic acid and 1.8 parts of n-octylmercaptan, and the initiator solution was replaced of an initiator solution of 6.1 parts of potassium persulfate dissolved in 237 parts of deionized water.

### Core Resin Particle 8

“Core resin particle 8” was prepared similarly to the foregoing core resin particle 3, except that in the 2nd polymerization step (outer layer formation), the monomer mixture was replaced by a mixture of 193.5 parts of styrene, 220.5 parts of n-butyl acrylate, 36 parts of methacrylic acid and 5.8 parts of n-octylmercaptan, and the initiator solution was replaced by an initiator solution of 5.1 parts of potassium persulfate dissolved in 197 parts of deionized water.

TABLE 1

| | Volume | Volume | | | |
|---|---|---|---|---|---|
| Core Resin | Average | Average | | | |
| Particle | Molecular | Particle | | | |
| No. | Weight (Mw) | Size (nm) | Tg1 (° C.) | Tsp | SP* |
| 1 | 26,800 | 125 | 28.1 | 83.1 | 10.09 |
| 6 | 28,400 | 171 | 11.7 | 66.7 | 10.2 |
| 7 | 25,800 | 175 | 38.2 | 93.2 | 10.09 |
| 8 | 26,300 | 169 | 8.7 | 65.5 | 10.19 |

*solubility parameter

### Preparation of Shell Resin Particle

Shell Resin Particle 1

Resin particles 1 used for forming shell layer (hereinafter, also denoted as shell resin particle 1) was prepared similarly to the foregoing core resin particle 1, except that in the 1st polymerization step, the monomer mixture was replaced by a mixture of 624 parts of styrene, 120 parts of 2-ethylhexyl acrylate, 56 parts of methacrylic acid and 16.4 parts of n-octylmercaptan.

### Shell Resin Particle 3

Shell Resin Particle 3 was prepared similarly to the foregoing shell resin particle 1, except that the monomer mixture was replaced by a mixture of 548 parts of styrene, 156 parts of 2-ethylhexyl acrylate, 96 parts of methacrylic acid and 16.5 parts of n-octylmercaptan.

### Shell Resin Particle 7

Shell Resin Particle 7 was prepared similarly to the foregoing shell resin particle 1, except that the monomer mixture was replaced by a mixture of 528 parts of styrene, 208 parts of 2-ethylhexyl acrylate, 64 parts of methacrylic acid and 16.5 parts of n-octylmercaptan.

### Shell Resin Particle 8

Shell Resin Particle 8 was prepared similarly to the foregoing shell resin particle 1, except that the monomer mixture was replaced by a mixture of 666.4 parts of styrene, 109.6 parts of 2-ethylhexyl acrylate, 24 parts of methacrylic acid and 16.5 parts of n-octylmercaptan.

TABLE 2

| | Volume | Volume | | |
|---|---|---|---|---|
| Shell Resin | Average | Average | | |
| Particle | Molecular | Particle | | |
| No. | Weight (Mw) | Size (nm) | Tg2 (° C.) | SP* |
| 1 | 18,600 | 118 | 61.0 | 10.48 |
| 3 | 18,000 | 117 | 53.0 | 10.6 |
| 7 | 18,300 | 120 | 40.1 | 10.3 |
| 8 | 28,500 | 123 | 60.9 | 10.27 |

*solubility parameter

### Preparation of Toner

Toners 1-15 were prepared in the manner described below.

### Preparation of Toner 1

### Colorant particle dispersion 1:

In 1600 parts of deionized water was dissolved 90 parts of the above-described anionic surfactant (formula 1). To the obtained solution was gradually added 400 parts of carbon black (Regal 330, produced by Cabot Co.) and dispersed using a stirrer (CLEAR MIX, M Technique Co., Ltd.) to obtain colorant particle dispersion 1.

The particle size of colorant particles of the colorant particle dispersion 1, which was measured by an electrophoretic light scattering photometer (ELS-800, produced by Otsuka Denshi Co.), was 110 nm.

### Formation of Core:

Into a reaction vessel provided with a stirrer, a temperature sensor, condenser tube and nitrogen introducing device were added 444 parts of core resin particle 1 and 900 parts of deionized water and stirred. After adjusting the temperature within the vessel to 30° C., an aqueous 5 mol/L sodium hydroxide solution was added thereto to adjust a pH to 8-11.

Subsequently, an aqueous solution of 2 parts of magnesium chloride hexahydrate dissolved in 1000 parts of deionized water was added over 10 min. at 30° C. After allowed to stand for 3 min., heating was started and the reaction system was heated to 65° C. in 60 min. In that state, the particle size was measured using Coulter Counter TA-II (produced by Coulter Beckman Corp.). When the volume-based median diameter (D₅₀) reached 5.5 μm, an aqueous solution of sodium chloride of 40.2 parts dissolved in 1000 parts of deionized was added water to terminate particle growth and the reaction mixture was further stirred for 1 hr. at 70° C. to continue fusion to form core 1. The circularity degree of the core 1, which was measured by EPIA 2100 (produced by Systex Co.), was 0.920.

### Formation of Shell:

Subsequently, 23.4 parts (converted to solid content) of the shell resin particle 1 was added at 65° C. and an aqueous solution of 2 parts of magnesium chloride hexahydrate dissolved in 1000 parts of deionized water was added in 10 min. Then, the temperature was raised to 70° C. (shelling temperature) and stirring continued for 1 hr. to allow particles of the shell resin particle 1 to be fused onto the particle surface of the core 1. Ripening was further conducted at 75° C. to form a shell layer until reached an intended circularity degree.

Further, 40.2 parts of sodium chloride was added and cooling to 30° C. was conducted at a rate of 8° C./min. Fused particles were filtered off, washed repeatedly with deionized water of 45° C. and then dried by hot air of 40° C., whereby particles of toner 1, comprising a core having thereon a shell layer.

The glass transition point (Tg) was determined in the manner, as afore-described.

The weight average molecular weight was determined in the manner, as afore-described.

### Preparation of Toners 2-15

Toners 2-15 were each prepared similarly to the foregoing Toner 1, provided that core resin particle 1 and shell resin particle 1 were replaced by a core resin particle described in Table 3 and a shell resin particle described in Table 3, respectively, and the circularity degree of core particles and shelling temperature were changed to those described in Table 3.

In each of the obtained toners 1-15, the section of toner particles were electron-microscopically observed through TEM, and the average of eight-point mean thickness (Have) and the average of (Hmax/Hmin) of the shell layer were determined according to the manner as afore-described.

Characteristic values of the individual toner are shown in Table 3.

TABLE 3

| Toner | Core Resin Particle | | | Shell Resin Particle | | | | | Core | Shell |
|---|---|---|---|---|---|---|---|---|---|---|
| No. | No. | Tg1 (° C.) | SP | No. | Tg2 (° C.) | ΔSP | Tg2 − Tg1 (° C.) | SP | (mass %) | (mass %) |
| 1 | 1 | 28.1 | 10.09 | 3 | 53 | 10.6 | 24.9 | 0.51 | 95 | 5 |
| 2 | 1 | 28.1 | 10.09 | 3 | 53 | 10.6 | 24.9 | 0.51 | 90 | 10 |
| 3 | 1 | 28.1 | 10.09 | 3 | 53 | 10.6 | 24.9 | 0.51 | 85 | 15 |
| 4 | 1 | 28.1 | 10.09 | 3 | 53 | 10.6 | 24.9 | 0.51 | 90 | 10 |
| 5 | 1 | 28.1 | 10.09 | 3 | 53 | 10.6 | 24.9 | 0.51 | 90 | 10 |
| 6 | 1 | 28.1 | 10.09 | 3 | 53 | 10.6 | 24.9 | 0.51 | 90 | 10 |
| 7 | 1 | 28.1 | 10.09 | 3 | 53 | 10.6 | 24.9 | 0.51 | 90 | 10 |
| 8 | 6 | 11.7 | 10.2 | 1 | 61 | 10.48 | 49.3 | 0.28 | 90 | 10 |
| 9 | 8 | 8.7 | 10.19 | 1 | 61 | 10.48 | 52.3 | 0.29 | 85 | 15 |
| 10 | 1 | 28.1 | 10.06 | 7 | 40.1 | 10.3 | 12 | 0.21 | 90 | 10 |
| 11 | 7 | 38.2 | 10.09 | 3 | 53 | 10.6 | 14.8 | 0.51 | 90 | 10 |
| 12 | 1 | 28.1 | 10.09 | 8 | 60.9 | 10.27 | 32.8 | 0.18 | 90 | 10 |
| 13 | 1 | 28.1 | 10.09 | 3 | 53 | 10.6 | 24.9 | 0.51 | 90 | 10 |
| 14 | 1 | 28.1 | 10.09 | 3 | 53 | 10.6 | 24.9 | 0.51 | 80 | 20 |
| 15 | 1 | 28.1 | 10.09 | 3 | 53 | 10.6 | 24.9 | 0.51 | 98 | 2 |

| Toner | Core Particle | Shelling | Shell Layer Thickness | | Toner D₅₀*¹ | Toner |
|---|---|---|---|---|---|---|
| No. | Circularity | Temperature (° C.) | Have. (nm) | Hmax/Hmin | (μm) | Circularity |
| 1 | 0.920 | 70 | 105 | 1.25 | 5.5 | 0.96 |
| 2 | 0.921 | 70 | 210 | 1.24 | 5.6 | 0.963 |
| 3 | 0.921 | 70 | 296 | 1.2 | 5.6 | 0.98 |
| 4 | 0.930 | 70 | 204 | 1.05 | 5.5 | 0.972 |
| 5 | 0.910 | 70 | 225 | 1.39 | 5.6 | 0.97 |
| 6 | 0.900 | 70 | 256 | 1.48 | 5.7 | 0.945 |
| 7 | 0.890 | 70 | 225 | 1.39 | 5.6 | 0.935 |
| 8 | 0.910 | 55 | 190 | 1.29 | 5.6 | 0.971 |
| 9 | 0.917 | 50 | 170 | 1.4 | 5.7 | 0.98 |
| 10 | 0.925 | 70 | 208 | 1.25 | 5.6 | 0.965 |
| 11 | 0.905 | 70 | 212 | 1.26 | 5.6 | 0.963 |
| 12 | 0.920 | 70 | 122 | 1.41 | 5.6 | 0.96 |
| 13 | 0.870 | 70 | 120 | 1.75 | 5.7 | 0.952 |
| 14 | 0.920 | 70 | 340 | 1.44 | 5.5 | 0.975 |
| 15 | 0.920 | 70 | 80 | 1.29 | 5.5 | 0.973 |

*¹volume-average median particle size of toner particle

### External Addition Treatment

To each of toners 1-18 were added a hydrophobic silica (number-average primary particle size of 12 nm and hydrophobicity of 68) in an amount of 1% by mass and a hydrophobic titanium oxide (number-average primary particle size of 20 nm and hydrophobicity of 63) in an amount of 1.2% by mass and mixed in a Henschel mixer to obtain toners 1-18.

### Preparation of Developer

Subsequently, each of the toners was mixed with an acryl resin-covered ferrite carrier at a volume-average particle size of 40 μm to prepare developers 1-18 exhibiting a toner concentration of 6%.

### Evaluation

Print images were prepared using a commercially available hybrid electrophotographic machine (Sitios 9331, produced by Konica Minolta Business Technologies Inc.) at a linear speed of 300 mm, using a developing roller of a 9 mm outer diameter, in which printing was conducted using each of the fixing device having a constitution of FIG. 3(A) and that of FIG. 3(B). The condition in the interior of the machine and printed images were evaluated.

Using the toners set forth above, Examples 1-12 and Comparative Examples 1-3 were evaluated below. In the evaluation, grades “A” and “B” were acceptable in practice and “C” was unacceptable in practice.

### Heat Stability

Each of the toners was placed in an amount of 0.5 g into a 10 ml vial having a inner diameter of 21 mm, capped and shaken 600 times, and after the cap was removed, the vial was allowed to stand for 2 hrs. under an environment of 55° C. and 35% RH. Subsequently, the toner was placed on a sieve of 40 mesh (an aperture of 350 μm) with paying attention not to break aggregated toner particles, set at a powder tester (produced by Hosokawa Micron Co.) and fixed by a pressing bar and a knob nut. After adjusted to a vibration strength with a feed width of 1 mm, vibration was applied for 10 sec. and then, the ratio (%) of the remained toner in the sieve was measured.

The toner aggregation ratio was calculated according to the following equation:

Toner aggregation ratio (%)={[residual toner on sieve (g)]/0.5 (g)}×100

Toners each were evaluated with respect to heat stability, based on criteria set forth below:
A: a toner aggregation ratio of less than 15% (excellent in heat stability),
B: a toner aggregation ratio of not less than 15% and not more than 20% (superior in heat stability),
C: a toner aggregation ratio of more than 20% (poor in heat stability).

### Low Temperature Fixability

In the fixing device of the foregoing machine, the surface temperature of the heating roller was varied so that the paper surface temperature was varied at intervals of 10° C. in the range of 80 to 150° C. and at each temperature, a toner image was fixed to form a fixed image. Print images were prepared on A4-size fine-quality paper (80 g/m²).

Fixing strength of the thus fixed print images was based on the fixing ratio obtained in accordance with a mending tape peeling method set forth in “Denshishashin Gijutsu no Kiso to Oyo” (Fundamentals and Application of Electrophotographic Techniques), edited by Denshishashin-Gakkai, chapter 9, sect. 1.4.

Specifically, there was prepared a black solid image of a 2.54 cm square, having a toner coverage of 0.6 mg/cm². Image densities were measured before and after being peeled by Scotch Mending Tape (produced by Sumitomo 3M Co.) and the residual ratio of image density was determined as the fixing ratio. The surface temperature of the transfer material (paper) at which a fixing ratio of 95% or more was achieved was defined as the minimum fixing temperature. The surface temperature of the transfer material (paper) was measured by a non-contact thermometer. Image densities were measured using a reflection densitometer (RD-918, produced by Macbeth Co.).

Low temperature fixability was evaluated based on the following criteria:
A: being fixable at a minimum fixing temperature of less than 100° C.,
B: being fixable at a minimum fixing temperature of not less than 100° C. and less than 130° C.,
C: being fixable at a minimum fixing temperature of not less than 130° C.

### Fixed Image Dislocation

To evaluation dislocation of a fixed image, images in which a single color solid image was overall on an A4-size recording sheet (transfer material) and further thereon, 10 lines (0.5 mm width) of another color were printed at intervals of 5 mm vertically to the moving direction of the recording sheet, were outputted on 100 sheets. The presence/absence of occurrence of image dislocation was observed, based on the following criteria, in which grades A and B were acceptable in practice.

A: no image dislocation was observed,

B: one to four image locations were observed,

C: five or more image dislocations were observed.

### Toner Scattering

There was also evaluated charge-rising performance at the time when supplying a toner to the developing device. Specifically, after printing of 1,000 sheets was conducted in a printing mode of markedly large toner consumption (feed rate) using an original of a relatively large imaging area exhibiting a picture element ratio of at least 75%, there was visually evaluated toner scattering in the interior of the machine, due to failure in charge-rise, based on the following criteria:
A: no staining due to toner scattering was observed,
B: slight staining due to toner scattering was observed but acceptable in practice,
C: obvious staining due to toner scattering was observed and unacceptable in practice.

TABLE 4

| | | | | Fixed Image | | |
|---|---|---|---|---|---|---|
| | | | | Dislocation | | |
| | | | Low | Fixing | Fixing | |
| Example | Toner | Heat | Temperature | Device | Device | Toner |
| No. | No. | Stability | Fixability | (A) | (B) | Scattering |
| 1 | 1 | A | A | A | A | A |
| 2 | 2 | A | A | A | A | A |
| 3 | 3 | A | A | A | A | A |
| 4 | 4 | A | A | A | A | A |
| 5 | 5 | A | A | A | A | A |
| 6 | 6 | A | A | A | A | B |
| 7 | 7 | B | B | A | A | A |
| 8 | 8 | B | A | B | B | A |
| 9 | 9 | B | A | B | B | A |
| 10 | 10 | B | A | B | B | A |
| 11 | 11 | B | A | B | B | A |
| 12 | 12 | B | A | A | A | B |
| Comp. 1 | 13 | C | B | C | C | C |
| Comp. 2 | 14 | B | C | A | A | C |
| Comp. 3 | 15 | C | A | C | C | B |

With respect to heat stability, low temperature stability and toner scattering, evaluation results were the same in fixing devices (A) and (B), and with respect to fixed image dislocation, the respective results were shown in Table 5.

As apparent from Table 4, it was proved that Examples 1-12 exhibited superior characteristics, but Comparative Examples 1-3 produced problems in any of characteristics.

When printing was conducted at a printing rate of 400 mm/sec, 490 mm/sec and 600 mm/sec and evaluation was made similarly, superior results were obtained in Examples 1-15 with respect to any of evaluation items.

What is claimed is:

1. An image forming method comprising the steps of:
forming a toner image with a toner through an electrophotographic system,
transferring the toner image onto a recording medium and
fixing the transferred toner image in a fixing device comprising a heating roller, an endless belt pressed into contact with the heating roller, a pressing member pressing the inner side of the endless belt and an end pressing member to locally elastically deform the heating roller and provided downstream from the pressing member,
wherein the toner comprises toner particles, and the toner particles each comprise a core containing a resin, a colorant and a releasing agent and having a shell on the core; the toner particles exhibit an average of eight-point mean thickness of the shell of 100 to 300 nm and meet a requirement of an average of Hmax/Hmin being less than 1.50, wherein Hmax is a maximum thickness of the shell and Hmin is a minimum thickness of the shell.

2. The image forming method of claim 1, wherein at least 80% by number of total toner particles is accounted for by a toner particle having a shell exhibiting an eight-point mean thickness of 100 to 300 nm.

3. The image forming method of claim 2, wherein the average of Hmax/Hmin is not less than 1.05 and less than 1.50.

4. The image forming method of claim 3, wherein each of the shell and the core contains a styrene-acrylic copolymer resin

5. The image forming method of claim 1, wherein the average of Hmax/Hmin is not less than 1.05 and less than 1.50.

6. The image forming method of claim 1, wherein the average of Hmax/Hmin is not less than 1.05 and less than 1.40.

7. The image forming method of claim 1, wherein the core accounts for at least 85% by mass and the shell accounts for 2 to 15% by weight, based on the total mass of the toner.

8. The image forming method of claim 1, wherein the core comprises a resin exhibiting a glass transition point of Tg1 and the shell comprises a resin exhibiting a glass transition point of Tg2, and the toner meeting the following requirement:
Tg2−Tg1≧15° C., 20 C.≦Tg1≦40° C. and 40° C.≦Tg2.

9. The image forming method of claim 8, wherein each of the shell and the core contains a styrene-acrylic copolymer resin

10. The image forming method of claim 8, wherein Tg2-Tg1≧20° C.

11. The image forming method of claim 1, wherein the toner particles exhibit an average circularity degree of not less than 0.945.

12. The image forming method of claim 1, wherein core particles exhibit an average circularity degree of 0.900 to 0.930.

13. The image forming method of claim 1, wherein a difference (ASP) in solubility parameter between the core and the shell is from 0.2 to 1.0.

14. The image forming method of claim 13, wherein the difference (ΔSP) is from 0.25 to 0.95.

15. The image forming method of claim 1, wherein each of the shell and the core contains a styrene-acrylic copolymer resin

16. The image forming method of claim 15, wherein the styrene-acrylic copolymer resin contained in the core is derived from at least one of propyl acrylate, propyl methacrylate, butyl acrylate and 2-ethylhexylacrylate.

17. The image forming method of claim 15, wherein the styrene-acrylic copolymer resin contained in the shell is derived from at least one of styrene, methyl methacrylate and methacrylic acid.

18. The image forming method of claim 1, wherein the transferred toner image in a fixing device is fixed at the temperature of surface of the heating roller not more than 150° C.
